(19) United States
(12) Patent Application Publication
(10) Pub. No.: US 2020/0229649 A1
(43) Pub. Date: Jul. 23, 2020

(54) CUP WITH JUICING FUNCTION AND CUP WITH MILK FROTHING FUNCTION

(71) Applicant: ZHEJIANG SHUOQI ELECTRIC APPLIANCE CO., LTD., YUYAO CITY (CN)

(72) Inventors: JUNDA SHI, YUYAO CITY (CN); ZHONGYU SHI, YUYAO CITY (CN); SHUKUO LIU, YUYAO CITY (CN); XIAOLEI CHEN, YUYAO CITY (CN)

(21) Appl. No.: 16/505,893

(22) Filed: Jul. 9, 2019

(30) Foreign Application Priority Data
Jan. 23, 2019 (CN) 201910062142.3

(51) Int. Cl. A47J 43/07

(52) U.S. Cl. CPC A47J 43/0766; A47J 43/0716

(57) ABSTRACT

Some embodiments of the present disclosure provide a cup with a juicing function and a cup with a milk frothing function. Each of the two cups includes a cup body, a cup base, a motor, and a control assembly. There is accommodated space between a base body of the cup base and a bottom cover. The motor and the control assembly are disposed inside the accommodated space. An annular groove is disposed in an upper surface of the base body. A first through-hole is disposed at the bottom of the annular groove. A first seal ring is disposed inside the annular groove. An output shaft of the motor passes upwards through the base body and is connected to a blade or a milk froth stirring head. The output shaft of the motor is in sealed connection with the base body through a second seal ring.

### CROSS REFERENCE TO RELATED APPLICATIONS

This application claims priority to Chinese application number 20191006214-2.3 filed on Jan. 23, 2019, the disclosure of which is incorporated by reference herein in its entirety.

### FIELD OF THE DISCLOSURE

The disclosure relates generally to the field of mechanical stirring apparatus. More specifically, the disclosure relates to a cup with a juicing function and a cup with a milk frothing function.

### BACKGROUND

Fruit juice is a juice product prepared from fruit by using physical methods such as squeezing, centrifugation, extraction, and the like, and generally refers to pure fruit juice or 100% fruit juice. Many nutrient components in fruit are retained in fruit juice, such as vitamins, minerals, sugars, and pectin in dietary fiber. The research shows that long-term use of fruit juice can enhance immunity, reduce illness, delay senility, reduce risks of cancers in a digestive system, a bladder, and a respiratory tract, and can effectively prevent atherosclerosis and coronary insufficiency.

With the increasing popularity of coffee in China, lovers of milk coffee such as cappuccino or latte particularly favor milk frothers. After milk frothing, milk froths taste very good when they burst in a mouth, improving drinking experience of coffee. In addition, coffee art design can be carried out to enhance a visual aesthetic feeling.

Existing juicing cups and milk frothers are divided in to an electric type and a manual type. Juicing efficiency of an electric juicing cup and an electric milk frother are relatively high. After being powered on, the electric juicing cup or the electric milk frother can work only by turning on a switch. In this case, when a cup body is not installed on a cup base, there is a hidden danger when the electric juicing cup or the electric milk frother works. This easily affects personal safety of a user.

Some prior art discloses using a magnetic switch, that is, when a cup body and a cup base are screwed together, a magnet disposed at a lower part of the cup body is close to a magnetic switch on the cup base, and the magnetic switch is switched on under an action of a magnetic field of the magnet. Then a control switch is switched on, so that a circuit is turned on, and therefore juicing elements works normally. However, if the magnet is large, installation and sealing of a cup mouth is affected; if the magnet is small, magnetic induction is not sensitive enough, especially after a long time of use, sensitivity of the magnetic switch will decrease significantly.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

Some embodiments of the disclosure provide a cup with a juicing function and a cup with a milk frothing function that have high safety and switch sensitivity.

In some embodiments, a cup with a juicing function includes a cup body, a cup base, a motor, and a control assembly. The cup base includes a base body and a bottom cover that are connected to each other. There is accommodated space between the base body and the bottom cover, and the motor and the control assembly are disposed inside the accommodated space. An annular groove is disposed in an upper surface of the base body, and a first through-hole is disposed at the bottom of the annular groove. A first seal ring is also disposed inside the annular groove. A cup mouth of the cup body is in threaded connection with the annular groove, so that the cup mouth of the cup body can be abutted against the first seal ring. An output shaft of the motor passes upwards through the base body and is connected to a blade. The output shaft of the motor is in sealed connection with the base body through a second seal ring. The control assembly includes a guide rod, a spring, a seal cartridge, and a PCB control panel. A touch switch and a USB interface that are electrically connected to the PCB control panel are disposed on the PCB control panel. An opening is disposed in a position, corresponding to the USB interface, on the bottom cover. An upper part of the guide rod is movably disposed inside the first through-hole. The seal cartridge is sleeved on the upper part of the guide rod. The upper part of the guide rod is in sealed connection with the base body through the seal cartridge. There is a first limiting position and a second limiting position when the guide rod slides in a vertical direction. When the guide rod is at the first limiting position, a top part of the guide rod extends upwards out of the bottom of the annular groove, and the guide rod is separated from the touch switch. When the guide rod is at the second limiting position, a partial structure of the guide rod is in contact with the touch switch, so as to switch on a power source of the motor, the spring can make the guide rod return to the first limiting position when the guide rod is at the second limiting position, and a vertical projection of the cup mouth of the cup body overlaps partially with the seal cartridge.

Optionally, a silica gel pad is disposed on a lower surface of the bottom cover.

Optionally, the cup further includes a USB interface protecting cover. The USB interface protecting cover is fastened to the base body, the bottom cover, or the PCB control panel through a flexible extension part, and the USB interface protecting cover is detachably connected to the opening.

Optionally, the motor is a 5V direct-current motor.

Optionally, the guide rod includes a first vertical rod, a second vertical rod, a third vertical rod, and a cross bar. A lower end of the first vertical rod, a lower end of the second vertical rod, and an upper end of the third vertical rod are fastened to the cross bar. A vertical guide groove is disposed in a lower surface of the base body. The first vertical rod is slidably disposed inside the vertical guide groove. The seal cartridge is sleeved on an upper part of the second vertical rod.

Optionally, the spring is sleeved outside the third vertical rod, an upper end of the spring is abutted against the cross bar, and a lower end of the spring is abutted against the bottom cover.

Optionally, the bottom cover is fixedly connected to the base body through a tapping screw.

Optionally, a plurality of stand columns is disposed on a lower surface of the base body. A threaded hole is disposed in a lower surface of the stand column. A second through-hole is disposed in a position, corresponding to the threaded hole, on the bottom cover. An upper end of the tapping screw passes through the second through-hole and is in threaded connection with the threaded hole.

In other embodiments, a cup with a milk frothing function includes a cup body, a cup base, a motor, and a control assembly. The cup base includes a base body and a bottom cover that are connected to each other. There is accommodated space between the base body and the bottom cover. The motor and the control assembly are disposed inside the accommodated space. An annular groove is disposed in an upper surface of the base body. A first through-hole is disposed at the bottom of the annular groove. A first seal ring is disposed inside the annular groove. A cup mouth of the cup body is in threaded connection with the annular groove, so that the cup mouth of the cup body can be abutted against the first seal ring. An output shaft of the motor passes upwards through the base body and is connected to a milk froth stirring head. The output shaft of the motor is in sealed connection with the base body through a second seal ring. The control assembly includes a guide rod, a spring, a seal cartridge, and a PCB control panel. A touch switch and a USB interface that are electrically connected to the PCB control panel are disposed on the PCB control panel. An opening is disposed in a position, corresponding to the USB interface, on the bottom cover. An upper part of the guide rod is movably disposed inside the first through-hole. The seal cartridge is sleeved on the upper part of the guide rod. The upper part of the guide rod is in sealed connection with the base body through the seal cartridge.

There is a first limiting position and a second limiting position when the guide rod slides in a vertical direction. When the guide rod is at the first limiting position, a top part of the guide rod extends upwards out of the bottom of the annular groove, and the guide rod is separated from the touch switch. When the guide rod is at the second limiting position, a partial structure of the guide rod is in contact with the touch switch, so as to switch on a power source of the motor, the spring can make the guide rod return to the first limiting position when the guide rod is at the second limiting position, and a vertical projection of the cup mouth of the cup body overlaps partially with the seal cartridge.

Optionally, a silica gel pad is disposed on a lower surface of the bottom cover.

Optionally, the cup with a milk frothing function further includes a USB interface protecting cover. The USB interface protecting cover is fastened to the base body, the bottom cover, or the PCB control panel through a flexible extension part, and the USB interface protecting cover is detachably connected to the opening.

Optionally, the motor is a 5V direct-current motor.

Optionally, the guide rod includes a first vertical rod, a second vertical rod, a third vertical rod, and a cross bar. A lower end of the first vertical rod, a lower end of the second vertical rod, and an upper end of the third vertical rod are fastened to the cross bar. A vertical guide groove is disposed in a lower surface of the base body. The first vertical rod is slidably disposed inside the vertical guide groove. The seal cartridge is sleeved on an upper part of the second vertical rod.

Optionally, the spring is sleeved outside the third vertical rod, an upper end of the spring is abutted against the cross bar, and a lower end of the spring is abutted against the bottom cover.

Optionally, the bottom cover is fixedly connected to the base body through a tapping screw.

Optionally, a plurality of stand columns is disposed on a lower surface of the base body. A threaded hole is disposed in a lower surface of the stand column. A second through-hole is disposed in a position, corresponding to the threaded hole, on the bottom cover. An upper end of the tapping screw passes through the second through-hole and is in threaded connection with the threaded hole.

### BRIEF DESCRIPTION OF THE DRAWINGS

FIG. 1 is a schematic structural diagram of a cup with a juicing function.

FIG. 2 is a schematic structural diagram of FIG. 1 from which a cup body is removed.

FIG. 3 is a schematic structural diagram of a base body.

FIG. 4 is a schematic structural diagram of a switch guide rod.

FIG. 5 is a schematic structural diagram of a seal cartridge.

FIG. 6 is a schematic structural diagram of a bottom cover.

FIG. 7 is a schematic structural diagram of a USB interface protecting cover.

FIG. 8 is a schematic diagram of an installation manner of a milk froth stirring head.

### DETAILED DESCRIPTION

The described embodiments are merely a part rather than all of the embodiments of the present invention. All other embodiments obtained by a person of ordinary skill in the art based on the embodiments of the present invention without creative efforts shall fall within the protection scope of the present invention

In some embodiments, the disclosure may provide a cup with a juicing function and a cup with a milk frothing function that have high safety and switch sensitivity.

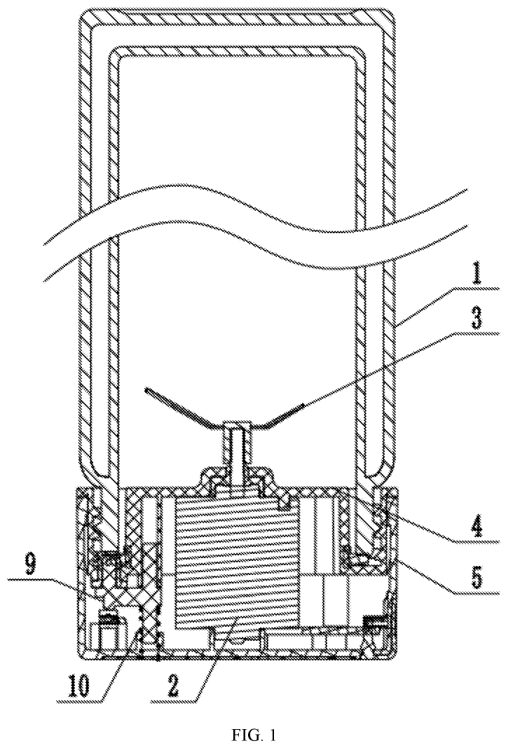

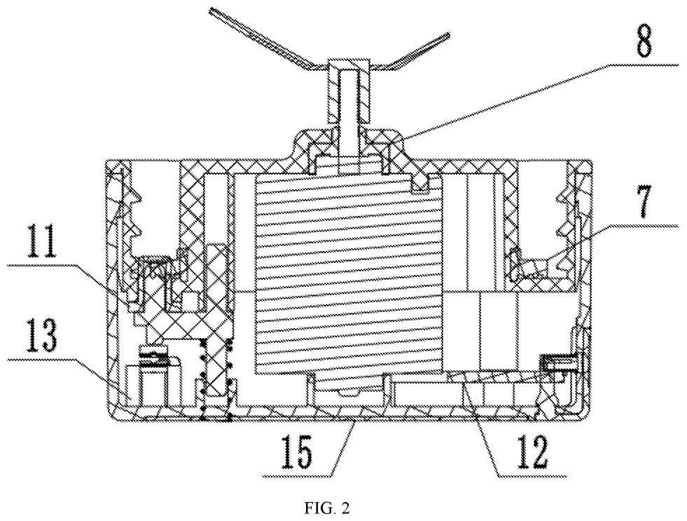

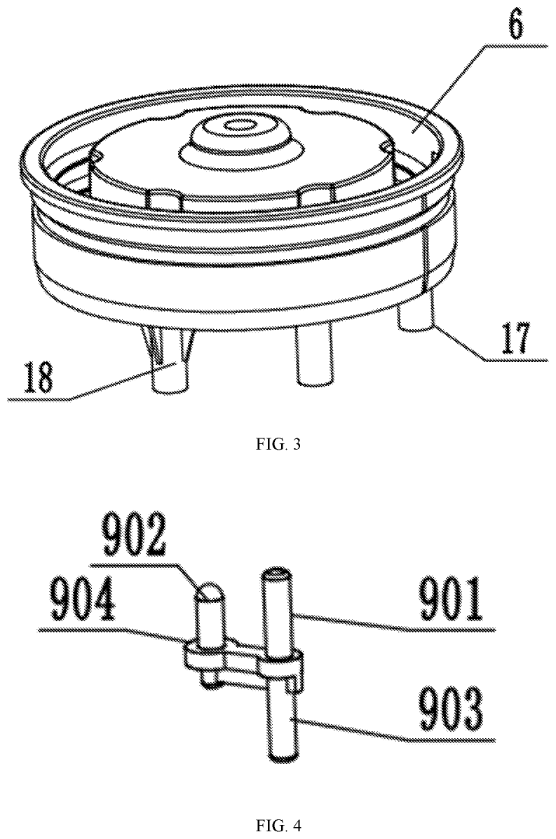

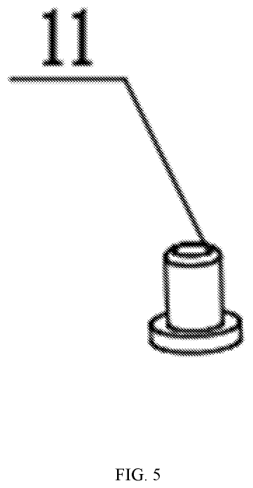

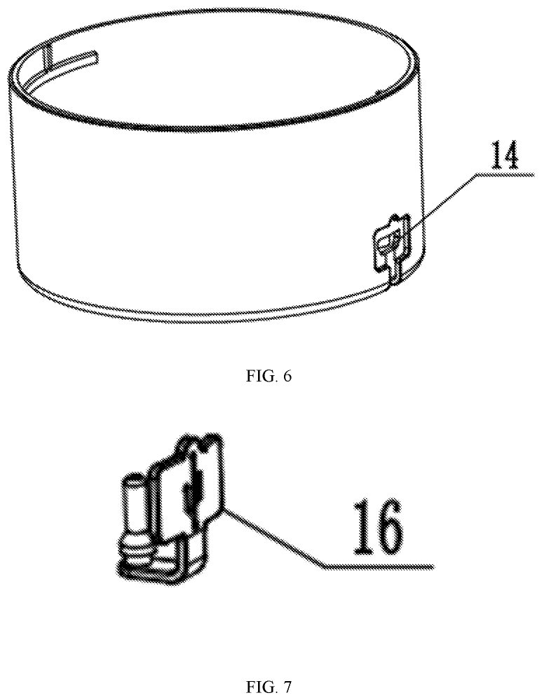

The following describes multiple exemplary embodiments of the disclosure with reference to the accompanying drawings. In FIGS. 1-8, 1 represents cup body, 2 represents motor, 3 represents blade, 4 represents base body, 5 represents bottom cover, 6 represents annular groove, 7 represents first seal ring, 8 represents second seal ring, 9 represents guide rod, 10 represents spring, 11 represents seal cartridge, 12 represents PCB control panel, 13 represents touch switch, 14 represents USB interface, 15 represents silica gel pad, 16 represents USB interface protecting cover, 17 represents stand column, 18 represents vertical guide groove, 19 represents milk froth stirring head, 901 represents first vertical rod, 902 represents second vertical rod, 903 represents third vertical rod, and 904 represents cross bar.

### Embodiment 1

As shown in FIG. 1 to FIG. 8, an embodiment provides a cup with a juicing function, including a cup body 1, a cup base, a motor 2, and a control assembly. The cup body 1 and the cup base are connected in a separable manner. After a fruit is placed inside the cup body 1, the cup body 1 is installed on the cup base, and a power source is switched on for the motor 2 by operating the control assembly, so as to implement fruit stirring. The cup body 1 may be a vacuum stainless mug, a vacuum glass cup, a common glass cup, a plastic cup, and the like, and may be selected according to actual requirements.

The cup base includes a base body 4 and a bottom cover 5 that are connected to each other. There is accommodated space between the base body 4 and the bottom cover 5, and the motor 2 and the control assembly are disposed inside the accommodated space. An annular groove 6 is disposed in an upper surface of the base body 4. A first through-hole is disposed at the bottom of the annular groove 6, and a first seal ring 7 is disposed inside the annular groove 6. A cup mouth of the cup body 1 is in threaded connection with the annular groove 6, so that the cup mouth of the cup body 1 may be abutted against the first seal ring 7 during rotation. An output shaft of the motor 2 passes upwards through the base body 4 and is connected to a blade 3. The output shaft of the motor 2 is in sealed connection with the base body 4 through a second seal ring 8. The control assembly includes a guide rod 9, a spring 10, a seal cartridge 11, and a PCB control panel 12. A touch switch 13 and a USB interface 14 that are electrically connected to the PCB control panel 12 are disposed on the PCB control panel 12. An opening is disposed in a position, corresponding to the USB interface 14, on the bottom cover 5. An upper part of the guide rod 9 is movably disposed inside the first through-hole. The seal cartridge 11 is sleeved on the upper part of the guide rod 9, and the upper part of the guide rod 9 is in sealed connection with the base body 4 the seal cartridge 11.

There is a first limiting position on an upper side and a second limiting position on a lower side when the guide rod 9 slides in a vertical direction. When the guide rod 9 is at the first limiting position, a top part of the guide rod 9 extends upwards out of the bottom of the annular groove 6, and the guide rod 9 is separated from the touch switch 13 such that an inner circuit of the touch switch 13 is cut off. A power supply circuit of the motor 2 is accordingly cut off. When the guide rod 9 is at the second limiting position, a partial structure of the guide rod 9 is in contact with the touch switch 13, and the inner circuit of the touch switch 13 is closed, so as to make the power supply circuit of the motor 2 switched on. The spring 10 may make the guide rod 9 return to the first limiting position when the guide rod 9 is at the second limiting position. A vertical projection of the cup mouth of the cup body 1 overlaps partially with the seal cartridge 11.

During use of the cup with a juicing function in some embodiments, a fruit is loaded inside the cup body 1 first. A cup mouth of the cup body 1 is then made to be in threaded connection with the annular groove 6 of the cup base after the cup base is inverted. The cup body 1 continues to be rotated, and the cup body 1 drives the guide rod 9 to move from the first limiting position to the second limiting position. In this case, rotation of the cup body 1 is stopped, and the cup mouth of the cup body 1 is sealed by using the first seal ring 7. The cup base is restored to an upright position, a power line is connected to the USB interface 14 to power on the motor 2, and the output shaft of the motor 2 drives the blade 3 to rotate, so as to implement cutting and stirring of the fruit. The second seal ring 8 may prevent fruit juice in the cup body 1 from leaking downwards to a position of the motor 2.

Further, in some embodiments, a silica gel pad 15 is disposed on a lower surface of the bottom cover 5, and equally distributed bump structures are disposed on a lower surface of the silica gel pad 15, which may improve a slide-proof property and reduce shake and noise.

A USB interface protecting cover 16 may further be disposed to prevent water or dust from entering the accommodated space between the base body 4 and the bottom cover 5. The USB interface protecting cover 16 is fastened to the base body 4, the bottom cover 5, or the PCB control panel 12 through a flexible extension part, and the USB interface protecting cover 16 is detachably connected to the opening. When juicing is not required, the opening on the bottom cover 5 may be closed by using the USB interface protecting cover 16. In some embodiments, the USB interface protecting cover 16 is connected to the bottom cover 5 through a plastic strip.

The motor 2 in some embodiments is a 5V direct-current motor, and may be supplied with power by using a conventional 5V and 2V mobile phone adaptor or a portable power source conveniently and rapidly.

There are multiple forms for a structure of the guide rod 9, as long as the guide rod 9 may be in contact with the light touch switch 13 under drive of the cup body 1 and may be separated from the touch switch 13 under an action of the spring 10. In some embodiments, the guide rod 9 includes a first vertical rod 901, a second vertical rod 902, a third vertical rod 903, and a cross bar 904, and a lower end of the first vertical rod 901, a lower end of the second vertical rod 902, and an upper end of the third vertical rod 903 are fastened to the cross bar 904. A vertical guide groove 18 is disposed in a lower surface of the base body 4. The first vertical rod 901 is slidably disposed inside the vertical guide groove 18. An outer wall of the vertical guide groove 18 is connected to the base body 4 through a ribbed plate. The seal cartridge 11 is sleeved on an upper part of the second vertical rod 902. When sliding up and down, the second vertical rod 902 is sealed by the seal cartridge 11, to present the fruit juice in the cup body 1 from leaking into the accommodated space by using the first through-hole.

In some embodiments, the spring 10 is sleeved on an outer side of the third vertical rod 903. An upper end of the spring 10 is abutted against the cross bar 904, a lower end of the spring 10 is abutted against the bottom cover 5. A person skilled in the art may also arrange the spring 10 in another position, as long as the spring 10 may support the guide rod 9 flexibly.

In other embodiments, the bottom cover 5 is fixedly connected to the base body 4 through a tapping screw. A limiting end surface abutted against an upper limb of the bottom cover 5 is disposed outside the base body 4. Multiple stand columns 17 are disposed on a lower surface of the base body 4, and a threaded hole is disposed in a lower surface of the stand column 17. A second through-hole is disposed in a position, corresponding to the threaded hole, on the bottom cover 5, and an upper end of the tapping screw passes through the second through-hole and is in threaded connection with the threaded hole.

It should be noted that, to simultaneously implement sealing of the cup mouth and the driving of the guide rod 9 during rotation of the cup body 1, in further embodiments, a vertical projection of the cup mouth of the cup body 1 overlaps partially with the seal cartridge 11. A person skilled in the art may arrange a gap on the first seal ring 7, where a size and a shape of the gap are the same as those of the seal cartridge 11, so that the cup mouth of the cup body 1 may hold down the first seal ring 7 and the seal cartridge 11 simultaneously. The seal cartridge 11 may slide up and down inside the gap, and a person skilled in the art may also make the first seal ring 7 cover an upper side of the seal cartridge 11.

### Embodiment 2

Some embodiments of the disclosure provide a cup with a milk frothing function. A structure thereof is basically the same as a structure of the cup in Embodiment 1. A difference lies in only that: the blade 3 in Embodiment 1 is replaced by a milk froth stirring head 19 in some embodiments. For a type of the milk froth stirring head 19, a person skilled in the art may perform selection according to an actual requirement.

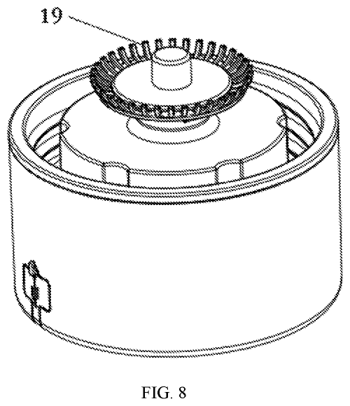

As shown in FIG. 8, the milk froth stirring head 19 includes a mounting plate and stirring rods evenly distributed on a circumferential surface of the mounting plate, and the mounting plate is fastened to an output shaft of a motor 2. The stirring rod is an arc-shaped rod, one end of the stirring rod is fastened to the circumferential surface of the mounting plate, and the other end of the stirring rod is bent upwards. Because the motor 2 is disposed in accommodated space of a cup base, that is, under a cup body 1, by making the other end of the stirring rod bent upwards, a stirring height of the stirring rod may be changed, and a stirring effect may be improved.

Various embodiments of the disclosure may have one or more of the following effects. A power supply circuit of the motor may be switched on at the same time the cup body is screwed. The operation process may be simple. The switch sensitivity and safety may be high. The motor may be a 5V direct-current motor which may be supplied with power using a conventional 5V and 2V mobile phone adaptor or a portable power source. The power supplying process may be convenient and rapid.

Several examples are used for illustration of the principles and implementation methods of the present invention. The description of the embodiments is used to help illustrate the method and its core principles of the present invention. In addition, those skilled in the art may make various modifications in terms of specific embodiments and scope of application in accordance with the teachings of the present invention. In conclusion, the content of this specification shall not be construed as a limitation to the invention

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A cup with a juicing function, comprising:
a cup body;
a cup base;
a motor; and
a control assembly;
wherein:
the cup base comprises a base body and a bottom cover that are connected to each other;
there is accommodated space between the base body and the bottom cover;
the motor and the control assembly are disposed inside the accommodated space;
an annular groove is disposed in an upper surface of the base body;
a first through-hole is disposed at a bottom of the annular groove;
a first seal ring is disposed inside the annular groove;
a cup mouth of the cup body is in threaded connection with the annular groove, so that the cup mouth of the cup body can be abutted against the first seal ring;
an output shaft of the motor passes upwards through the base body and is connected to a blade;
the output shaft of the motor is in sealed connection with the base body through a second seal ring;
the control assembly comprises a guide rod, a spring, a seal cartridge, and a PCB control panel;
a touch switch and a USB interface that are electrically connected to the PCB control panel are disposed on the PCB control panel;
an opening is disposed in a position, corresponding to the USB interface, on the bottom cover;
an upper part of the guide rod is movably disposed inside the first through-hole;
the seal cartridge is sleeved on the upper part of the guide rod;
the upper part of the guide rod is in sealed connection with the base body through the seal cartridge;
there is a first limiting position and a second limiting position when the guide rod slides in a vertical direction;
when the guide rod is at the first limiting position, a top part of the guide rod extends upwards out of the bottom of the annular groove, and the guide rod is separated from the touch switch;
when the guide rod is at the second limiting position, a partial structure of the guide rod is in contact with the touch switch, so as to switch on a power source of the motor, the spring can make the guide rod return to the first limiting position when the guide rod is at the second limiting position; and
a vertical projection of the cup mouth of the cup body overlaps partially with the seal cartridge.

2. The cup with a juicing function according to claim 1, wherein a silica gel pad is disposed on a lower surface of the bottom cover.

3. The cup with a juicing function according to claim 1, further comprising: a USB interface protecting cover, wherein:
the USB interface protecting cover is fastened to the base body, the bottom cover, or the PCB control panel through a flexible extension part; and
the USB interface protecting cover is detachably connected to the opening.

4. The cup with a juicing function according to claim 1, wherein the motor is a 5V direct-current motor.

5. The cup with a juicing function according to claim 1, wherein:
the guide rod comprises a first vertical rod, a second vertical rod, a third vertical rod, and a cross bar;
a lower end of the first vertical rod, a lower end of the second vertical rod, and an upper end of the third vertical rod are fastened to the cross bar;
a vertical guide groove is disposed in a lower surface of the base body;
the first vertical rod is slidably disposed inside the vertical guide groove; and
the seal cartridge is sleeved on an upper part of the second vertical rod.

6. The cup with a juicing function according to claim 5, wherein:
the spring is sleeved outside the third vertical rod;
an upper end of the spring is abutted against the cross bar; and
a lower end of the spring is abutted against the bottom cover.

7. The cup with a juicing function according to claim 1, wherein the bottom cover is fixedly connected to the base body through a tapping screw.

8. The cup with a juicing function according to claim 7, wherein:
a plurality of stand columns is disposed on a lower surface of the base body;
a threaded hole is disposed in a lower surface of the stand column;
a second through-hole is disposed in a position, corresponding to the threaded hole, on the bottom cover; and
an upper end of the tapping screw passes through the second through-hole and is in threaded connection with the threaded hole.

9. A cup with a milk frothing function, comprising:
a cup body;
a cup base;
a motor; and
a control assembly;
wherein:
the cup base comprises a base body and a bottom cover that are connected to each other;
there is accommodated space between the base body and the bottom cover; the motor and the control assembly are disposed inside the accommodated space;
an annular groove is disposed in an upper surface of the base body;
a first through-hole is disposed at a bottom of the annular groove;
a first seal ring is disposed inside the annular groove;
a cup mouth of the cup body is in threaded connection with the annular groove, so that the cup mouth of the cup body can be abutted against the first seal ring;
an output shaft of the motor passes upwards through the base body and is connected to a milk froth stirring head;
the output shaft of the motor is in sealed connection with the base body through a second seal ring;
the control assembly comprises a guide rod, a spring, a seal cartridge, and a PCB control panel;
a touch switch and a USB interface that are electrically connected to the PCB control panel are disposed on the PCB control panel;
an opening is disposed in a position, corresponding to the USB interface, on the bottom cover;
an upper part of the guide rod is movably disposed inside the first through-hole;
the seal cartridge is sleeved on the upper part of the guide rod;
the upper part of the guide rod is in sealed connection with the base body through the seal cartridge;
there is a first limiting position and a second limiting position when the guide rod slides in a vertical direction;
when the guide rod is at the first limiting position, a top part of the guide rod extends upwards out of the bottom of the annular groove, and the guide rod is separated from the touch switch;
when the guide rod is at the second limiting position, a partial structure of the guide rod is in contact with the touch switch, so as to switch on a power source of the motor, the spring can make the guide rod return to the first limiting position when the guide rod is at the second limiting position; and
a vertical projection of the cup mouth of the cup body overlaps partially with the seal cartridge.

10. The cup with a milk frothing function according to claim 9, wherein a silica gel pad is disposed on a lower surface of the bottom cover.

11. The cup with a milk frothing function according to claim 9, further comprising a USB interface protecting cover, wherein:
the USB interface protecting cover is fastened to the base body, the bottom cover, or the PCB control panel through a flexible extension part; and
the USB interface protecting cover is detachably connected to the opening.

12. The cup with a milk frothing function according to claim 9, wherein the motor is a 5V direct-current motor.

13. The cup with a milk frothing function according to claim 9, wherein:
the guide rod comprises: a first vertical rod, a second vertical rod, a third vertical rod, and a cross bar;
a lower end of the first vertical rod, a lower end of the second vertical rod, and an upper end of the third vertical rod are fastened to the cross bar;
a vertical guide groove is disposed in a lower surface of the base body;
the first vertical rod is slidably disposed inside the vertical guide groove; and
the seal cartridge is sleeved on an upper part of the second vertical rod.

14. The cup with a milk frothing function according to claim 13, wherein:
the spring is sleeved outside the third vertical rod;
an upper end of the spring is abutted against the cross bar; and
a lower end of the spring is abutted against the bottom cover.

15. The cup with a milk frothing function according to claim 9, wherein the bottom cover is fixedly connected to the base body through a tapping screw.

16. The cup with a milk frothing function according to claim 15, wherein:
a plurality of stand columns is disposed on a lower surface of the base body;
a threaded hole is disposed in a lower surface of the stand column;
a second through-hole is disposed in a position, corresponding to the threaded hole, on the bottom cover; and
an upper end of the tapping screw passes through the second through-hole and is in threaded connection with the threaded hole.
